(19) United States
(12) Patent Application Publication
(10) Pub. No.: US 2005/0226475 A1
(43) Pub. Date: Oct. 13, 2005

(54) Method of, and system for, accessing a home or dwelling

(76) Inventors: Mark Basile, Jericho, NY (US); Steven Kang, Jericho, NY (US)

Correspondence Address: WILLIAM COLLARD;COLLARD & ROE, P.C., 1077 NORTHERN BOULEVARD, ROSLYN, NY, 11576, US

(21) Appl. No.: 10/818,655

(22) Filed: Apr. 6, 2004

(51) Int. Cl. G06K 9/00; G06T 1/00

(52) U.S. Cl. 382/124; 340/5.53

(57) ABSTRACT

A standalone, self-contained device for accessing and preventing unauthorized access to a home or dwelling using biometrics technology. The device improves upon traditional security access methods such as garage door openers, door locks, and alarm systems, by eliminating the need for physical keys and passwords. An individual's unique biometrics characteristics are captured and stored within the device through a secure administrative process which is used to identify authorized users. The correct identification of an individual results in authorized access controlled by the device.

### FIELD OF THE INVENTION

The invention relates to the application and use of fingerprint-based biometric technology in a standalone, self contained device, to provide home-based security products for the consumer market. This document outlines the high-level design of a self contained biometrics-based fixed garage door opener which replaces traditional access methods (physical keys and codes) with fingerprint matching technology.

### BACKGROUND OF THE INVENTION

The need for improved access methods beyond physical keys and codes has accelerated research and development in the biometrics field. Biometrics technology has matured sufficiently, to bring to market, inexpensive and reliable security products based on fingerprint identification as a replacement to conventional access methods for the home security market.

### SUBSTITUTE SPECIFICATION SUMMARY OF THE INVENTION

The invention is a stand-alone electronic device that directly replaces the traditional fixed garage door opener by using a fingerprint sensor to identify a user.
The invention provides the same functionality as that of a traditional fixed garage door opener—to open and close a garage door.
The invention does not require the services of a central alarm station, computer, or special equipment to operate.
The invention improves upon the traditional method by eliminating the need for physical keys—do away with lost or stolen keys.
The invention improves upon the traditional method by eliminating the need for a numeric keypad—do away with remembering codes.
The invention improves upon the traditional method by providing better security controls—granting and revoking access to individuals (i.e. family members, contractors, house keepers).
The invention improves upon the traditional method by making physical breaches more difficult—invulnerable to copying of keys, guessing of codes, or short circuit attempts.

### BRIEF DESCRIPTION OF THE SUBSTITUTE DRAWINGS

The invention is composed of two components:

(1) Fingerprint Sensor Unit (Labeled “A” in FIG. 1)

The Fingerprint Sensor Unit is mounted next to (or near) the garage door on the outside. The unit contains a small fingerprint sensor chip capable of acquiring an individual's fingerprint image. This unit also contains an onboard processor capable of extracting the unique characteristics of the individual's fingerprint and convert the image to a fingerprint template which is then transmitted to the control unit (labeled “B”) for proper identification. LEDs on the unit provide visual feedback to the user indicating READY, WAIT, SUCCESS, or FAIL statuses.

(2) Control Unit (Labeled “B” in FIG. 1)

The Control Unit is mounted on the inside of the garage door. This unit is physically connected to the Fingerprint Sensor Unit to provide power and transmit data between the two components. The Control Unit is designed to perform three critical functions.

1. Enrollment

Before the identity of an individual can be determined via his/her fingerprints, it is necessary to first capture one or several fingerprint samples from the individual. This process is called enrollment. The samples, referred to as fingerprint templates, are stored in the Control Unit's non-volatile memory used for later comparisons.

2. Extraction and Matching

The extraction process involves software (or code) that interprets and converts the unique characteristics of an individual's fingerprint image into a fingerprint template. This template is an encoded representation of the image that is stored in the Control Unit's memory and is used for matching a “live” fingerprint with the enrolled fingerprint templates. Consequently, the fingerprint template cannot be reverse engineered to reconstitute the owner's fingerprint image thus eliminating security concerns due to theft of the device.

3. Identification

Identification is the process that attempts to answer the question “Do I know you?” which is also known as “one-to-many” search. This is different from verification or authentication (also known as “one-to-one” search) which attempts to answer the question “Are you who you claim to be?” Identification is performed by the Control Unit by comparing the live fingerprint template against the enrolled templates stored in memory. A found match implies success.

FIG. 2 illustrates the steps involved in the enrollment process as performed by the invention. The enrollment process usually involves the capture of more than one biometric sample to form a good composite sample. This process is managed by an authorized administrator using the secured administrative functions provided on the control unit.

FIG. 3 illustrates the steps involved in the identification process as performed by the invention. The identification process involves capturing a live biometric sample from an individual and comparing it to the stored samples within the control unit using the extraction and matching functions. A successful match results in the activation of a relay that triggers an external device.

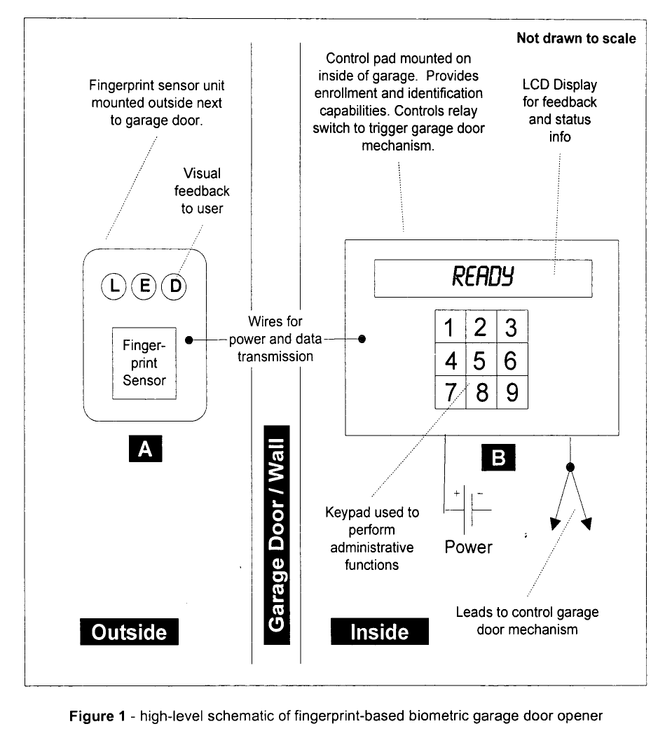

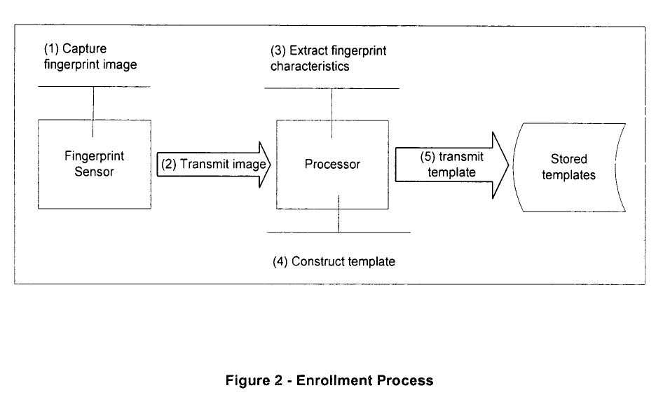

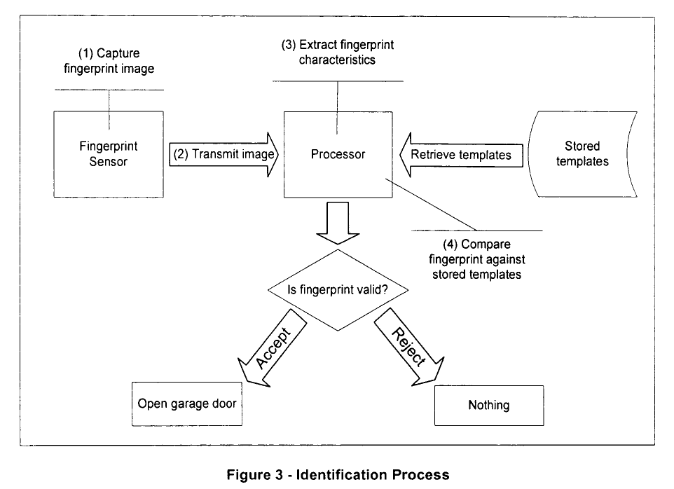

1. A method for accessing and preventing unauthorized access utilizing a stand-alone, non-computer based device, the procedure comprising the steps of:
a. An individual enrollment step, wherein an individual submits at least one biometric sample that is recorded and stored in the device;
b. An administrator or registration step that authorizes an individual access to the administration functions of the device.
c. A transmission step from the finger sensor to the control unit that forwards a live scanned biometric sample for enrollment or identification.
d. A user identification step, wherein the control unit compares the live sample with the previously stored enrolled samples.
e. A transmission step, wherein upon successful identification of the individual, a relay is activated to trigger an external device.

1. The method of claim 1, wherein the user identification process is accomplished, preferably within two seconds, whereby the entire identification and activation of the external device is completed within three seconds.

2. The method of claim 1, wherein all communication occurring within the device is self-contained exclusively with no external access or interface.

3. The method of claim 1, wherein the biometric sample is a fingerprint.
